(19) United States
(12) Patent Application Publication
(10) Pub. No.: US 2009/0217947 A1
(43) Pub. Date: Sep. 3, 2009

(54) Nebulizer rinse system and method of use

(76) Inventors: Daniel R. Wiederin, Omaha, NE (US); Patrick Sullivan, Omaha, NE (US)

Correspondence Address: SUITER SWANTZ PC LLO, 14301 FNB PARKWAY, SUITE 220, OMAHA, NE, 68154, US

(21) Appl. No.: 12/074,052

(22) Filed: Feb. 29, 2008

(51) Int. Cl. B08B 9/027; B08B 13/00; B08B 7/00

(52) U.S. Cl. 134/18; 134/22.11; 134/166 C; 134/57 R

(57) ABSTRACT

A method for providing rinsing of a nebulizer comprises directing a second rinsing liquid followed by a nebulizing gas to a gas receiving port of the nebulizer through a valve assembly, the valve assembly being connected to a gas transport line configured to transport at least one of the nebulizing gas and the second rinsing liquid to the gas receiving port; rinsing the sample transport line and an interior portion of the nebulizer with the first rinsing liquid; and rinsing an interior portion of the nebulizer with the second rinsing liquid transported through the gas transport line into the interior portion of the nebulizer via the gas receiving port.

### FIELD OF INVENTION

This invention relates to method of clearing potentially interfering residual sample from a nebulizer.

### BACKGROUND OF INVENTION

In many laboratory settings, it is often desired to convert liquid samples into aerosols prior to chemical analysis with a spectrometer or other analytical instrumentation. Such process is often performed by use of a self-aspirating nebulizer. For instance, liquid samples may be introduced into a nebulizer and aspirated into an aerosol. The aerosol may then be transferred from the nebulizer to a device suitable for analyzing the aerosol, such as an inductively coupled plasma mass spectrometry (ICP-MS) spectrometer. When multiple samples are consecutively transported through a nebulizer, particles of a previous sample may remain in the nebulizer, and may cause inaccurate analysis of subsequent samples.

Therefore, it would be desirable to provide a system and method for rinsing a nebulizer.

### SUMMARY OF INVENTION

Accordingly, the present invention is directed to a system and method for rinsing a nebulizer. According to a first embodiment, a method for rinsing a nebulizer is disclosed. The method for providing rinsing of a nebulizer includes, but is not limited to: directing a first rinsing liquid through a sample transport line to a sample receiving port of a nebulizer; directing a second rinsing liquid followed by a nebulizing gas to a gas receiving port of the nebulizer through a valve assembly, the valve assembly being connected to a gas transport line configured to transport at least one of the nebulizing gas and the second rinsing liquid to the gas receiving port; rinsing the sample transport line and an interior portion of the nebulizer with the first rinsing liquid; and rinsing an interior portion of the nebulizer with the second rinsing liquid transported through the gas transport line into the interior portion of the nebulizer via the gas receiving port. In addition to the foregoing, other computationally implemented method aspects are described in the claims, drawings, and text forming a part of the present disclosure.

According to a second embodiment, a system for rinsing a nebulizer is disclosed. The nebulizer rinsing system includes, but is not limited to: a liquid sample introduction line; a nebulizer, further including a plurality of nebulizer ports, at least one of the nebulizer ports being a sample introduction line receiving port and at least one of the nebulizer ports being a gas receiving port; a valve assembly configured to receive at least one of a nebulizer gas and a rinsing liquid; and a transport line configured to provide transportation of a rinsing liquid through the transport line to the gas receiving port of the nebulizer to rinse an interior portion of the nebulizer. In addition to the foregoing, other computationally implemented method aspects are described in the claims, drawings, and text forming a part of the present disclosure.

According to a third embodiment, an additional system for rinsing a nebulizer is disclosed. System includes, but is not limited to: a sample introduction line, a nebulizer further comprising a sample receiving port configured to receive a sample and a gas receiving port configured to receive at least one of a nebulizing gas from a gas source or a first rinsing liquid from a first rinsing liquid reservoir, a valve assembly configured to allow a portion of the gas or the rinsing liquid to flow therethrough; a gas transport line configured to transport at least one of the gas or the first rinsing liquid into an interior portion of the nebulizer through the gas receiving port; and a second rinsing liquid reservoir suitable for providing a second rinsing liquid transportable through the sample introduction line into an interior portion of the nebulizer via the sample receiving port. The sample is nebulized within the nebulizer by applying a nebulizer gas to the sample within the interior portion of the nebulizer, the nebulizer gas being directed into the nebulizer through the gas receiving port from a nebulizer gas source directed through a valve assembly, and the nebulizer is rinsed by directing the first rinsing liquid through the valve assembly to the gas transport line, transporting the first rinsing liquid into the nebulizer through the gas receiving port, and directing the second rinsing liquid through the sample introduction line into the nebulizer through the sample receiving port. In addition to the foregoing, other computationally implemented method aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The numerous objects and advantages of the present invention may be better understood by those skilled in the art by reference to the accompanying figures in which:

FIG. 1 illustrates an operational flow representing example operations related to providing a method for rinsing a nebulizer;

FIG. 2 illustrates an alternative embodiment of the operational flow of FIG. 1.

FIG. 3 illustrates an alternative embodiment of the operational flow of FIG. 1.

FIG. 4 illustrates an alternative embodiment of the operational flow of FIG. 1.

FIG. 5 illustrates an alternative embodiment of the operational flow of FIG. 1.

FIG. 6 is a schematic illustration of a system for development of a nebulized sample;

FIG. 7A is a detailed schematic illustration of a first embodiment of a system for development of a nebulized sample in analysis mode according to an exemplary embodiment of the invention;

FIG. 7B is a detailed schematic illustration of a first embodiment of a system for development of a nebulized sample in rinse mode according to an exemplary embodiment of the invention;

FIG. 8A is a detailed schematic illustration of a second embodiment of a system for development of a nebulized sample in analysis mode according to an exemplary embodiment of the invention;

FIG. 8B is a detailed schematic illustration of a second embodiment of a system for development of a nebulized sample in rinse mode according to an exemplary embodiment of the invention;

FIGS. 9A-9E are graphical illustrations of subsequent samples run through a conventional system plotted as the on-line intensity for Thorium on a logarithmic scale;

FIGS. 10A-10E are graphical illustrations of subsequent samples run through a system according to an exemplary embodiment of the invention plotted as the on-line intensity for Thorium on a logarithmic scale;

FIG. 11A is a detailed schematic illustration of a third embodiment of a system for development of a nebulized sample in analysis mode according to an exemplary embodiment of the invention; and

FIG. 11B is a detailed schematic illustration of a third embodiment of a system for development of a nebulized sample in rinse mode according to an exemplary embodiment of the invention.

### DETAILED DESCRIPTION OF INVENTION

Reference will now be made in detail to the presently preferred embodiments of the invention, examples of which are illustrated in the accompanying drawings.

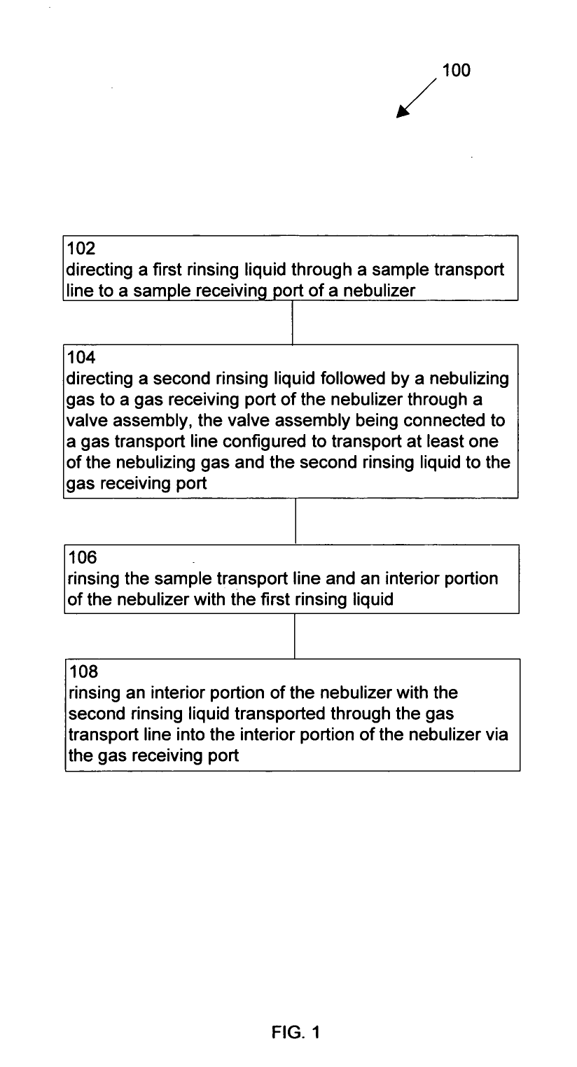

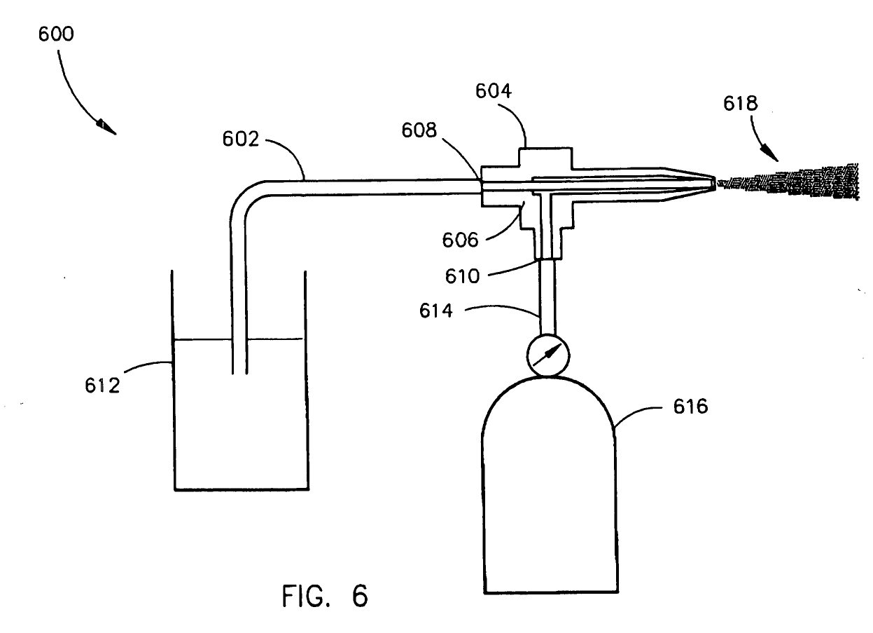

Referring to FIG. 1, an operational flow 100 representing example operations related to providing a method for rinsing a nebulizer according to an embodiment of the invention is illustrated. In FIG. 1 and in following figures that include various examples of operational flows, discussion and explanation may be provided with respect to the below-described examples of FIGS. 6-11 and/or with respect to other examples and contexts. However, it should be understood that the operational flows may be executed in a number of other environments and contexts, and/or in modified versions of FIGS. 6-11. Also, although the various operational flows are presented in the sequence(s) illustrated, it should be understood that the various operations may be performed in other orders than those which are illustrated, or may be performed concurrently.

Method 100 begins at an operation 102. Operation 102 depicts directing a first rinsing liquid through a sample transport line to a sample receiving port of a nebulizer. Operation 104 depicts directing a second rinsing liquid followed by a nebulizing gas to a gas receiving port of the nebulizer through a valve assembly, the valve assembly being connected to a gas transport line configured to transport at least one of the nebulizing gas and the second rinsing liquid to the gas receiving port. Operation 106 depicts rinsing the sample transport line and an interior portion of the nebulizer with the first rinsing liquid. Operation 108 depicts rinsing an interior portion of the nebulizer with the second rinsing liquid transported through the gas transport line into the interior portion of the nebulizer via the gas receiving port.

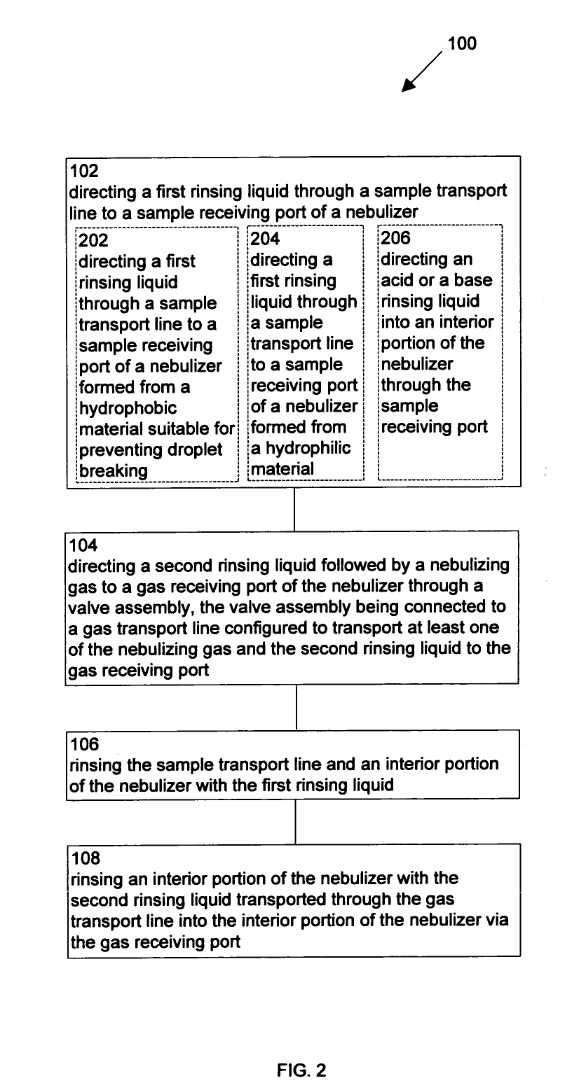

FIG. 2 illustrates alternative embodiments of the example operational flow 100 of FIG. 1. FIG. 2 illustrates example embodiments where the operation 102 may include at least one additional operation. Additional operations may include an operation 202, an operation 204, and/or an operation 206. Operation 202 illustrates directing a first rinsing liquid through a sample transport line to a sample receiving port of a nebulizer formed from a hydrophobic material suitable for preventing droplet breaking. Operation 204 illustrates directing a first rinsing liquid through a sample transport line to a sample receiving port of a nebulizer formed from a hydrophilic material. Operation 206 depicts directing an acid or a base rinsing liquid into an interior portion of the nebulizer through the sample receiving port.

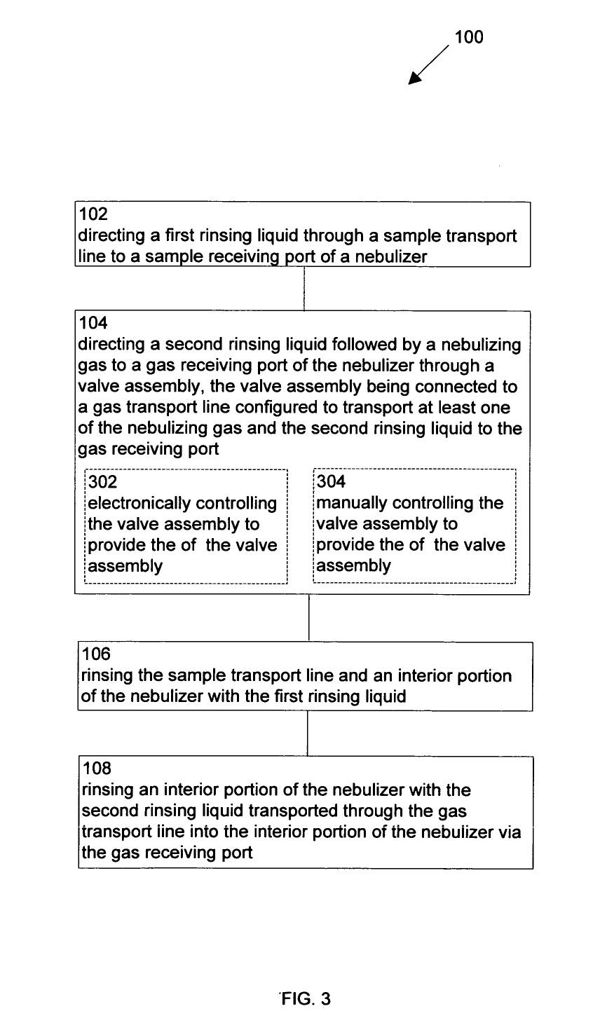

FIG. 3 illustrates alternative embodiments of the example operational flow 100 of FIG. 1. FIG. 3 illustrates example embodiments where the operation 104 may include at least one additional operation. Additional operations may include an operation 302 and/or operation 304. Operation 302 illustrates electronically controlling the valve assembly to introduce the rinsing liquid through the gas port. Operation 304 illustrates manually controlling the valve assembly to introduce the rinsing liquid through the gas port.

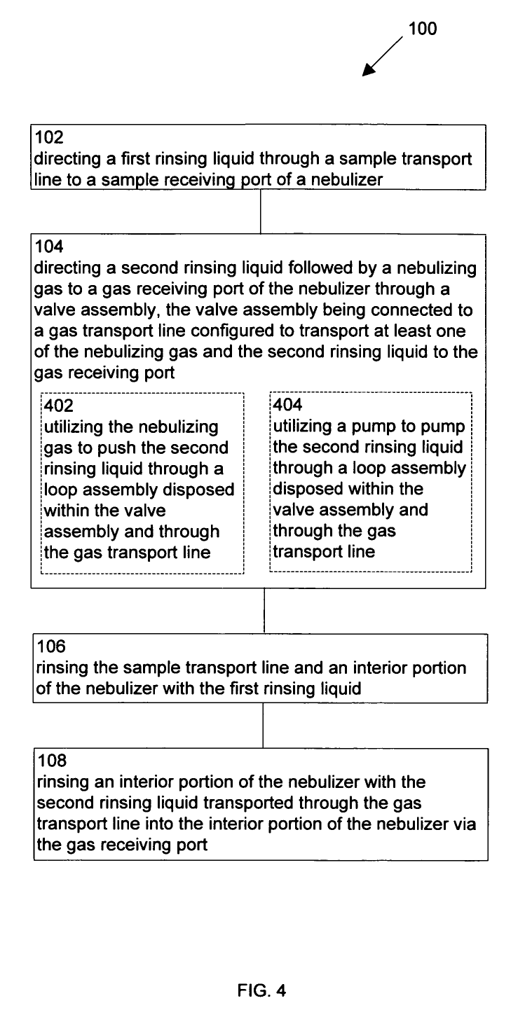

FIG. 4 illustrates alternative embodiments of the example operational flow 100 of FIG. 1. FIG. 4 illustrates example embodiments where the operation 102 may include at least one additional operation. Additional operations may include an operation 402 and/or operation 404. Operation 402 illustrates utilizing the nebulizing gas to push the second rinsing liquid through a loop assembly disposed within the valve assembly and through the gas transport line. Operation 404 illustrates utilizing a pump to pump the second rinsing liquid through a loop assembly disposed within the valve assembly and through the gas transport line.

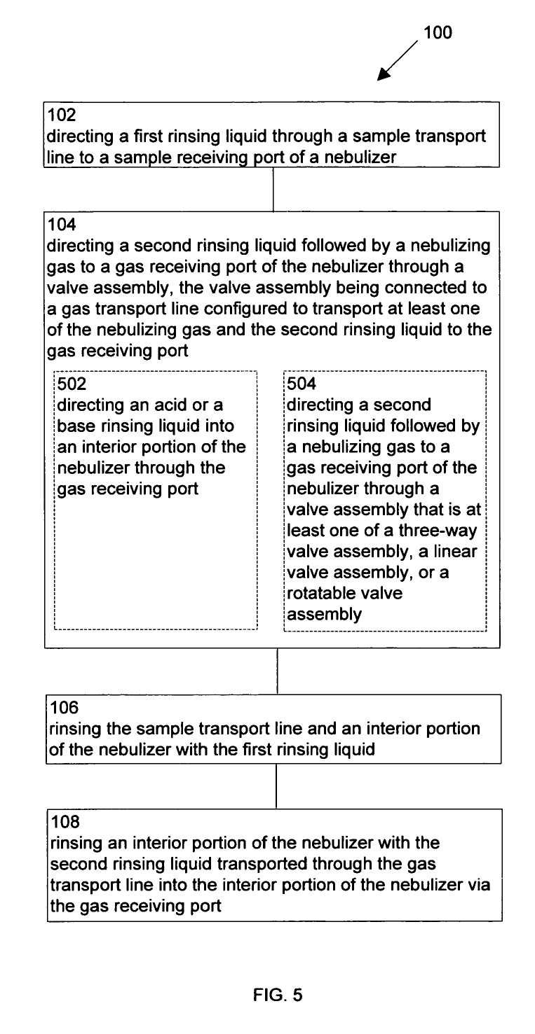

FIG. 5 illustrates alternative embodiments of the example operational flow 100 of FIG. 1. FIG. 5 illustrates example embodiments where the operation 104 may include at least one additional operation. Additional operations may include an operation 502 and/or operation 504. Operation 502 illustrates directing an acid or a base rinsing liquid into an interior portion of the nebulizer through the gas receiving port. Operation 504 illustrates directing a second rinsing liquid followed by a nebulizing gas to a gas receiving port of the nebulizer through a valve assembly that is at least one of a three-way valve assembly, a linear valve assembly, or a rotatable valve assembly.

Referring to FIG. 6, a schematic illustration of a system 600 for development of a nebulized sample, a detailed schematic illustration of a system 600 for development of a nebulized sample of a liquid for analysis in analysis mode according to an exemplary embodiment of the invention, and a detailed schematic illustration of a system 600 for development of a nebulized sample in rinse mode according to an exemplary embodiment of the invention are shown. System 600 may comprise a liquid sample introduction line 602, and a nebulizer 604. The nebulizer may further include an interior nebulizer portion 606 and a plurality of nebulizer ports 608, 610. At least one of the nebulizer ports may be a liquid sample receiving port 608 and at least one of the nebulizer ports may be a gas receiving port 610. System may also comprise a sample reservoir 612, a gas transport line 614 and a gas source 616. The liquid sample introduction line 602 may transport a sample from a sample reservoir 612 to the nebulizer 604 via the liquid sample receiving port 608 and the gas transport line 614 may transfer a gas from a gas source 616 to the nebulizer via the gas receiving port 610.

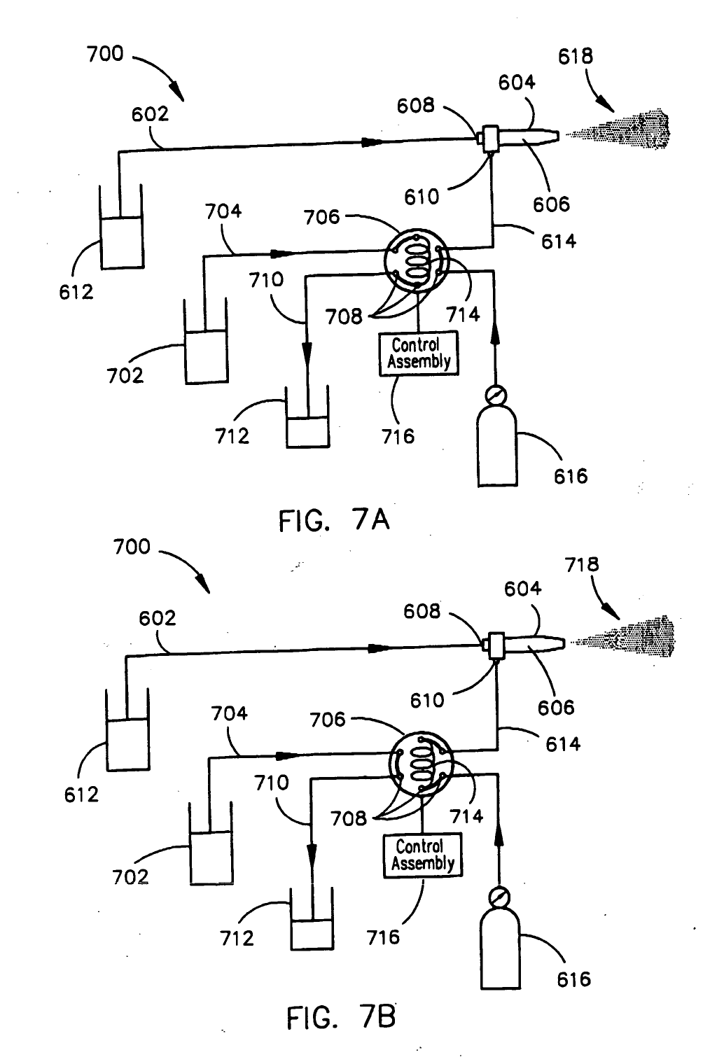

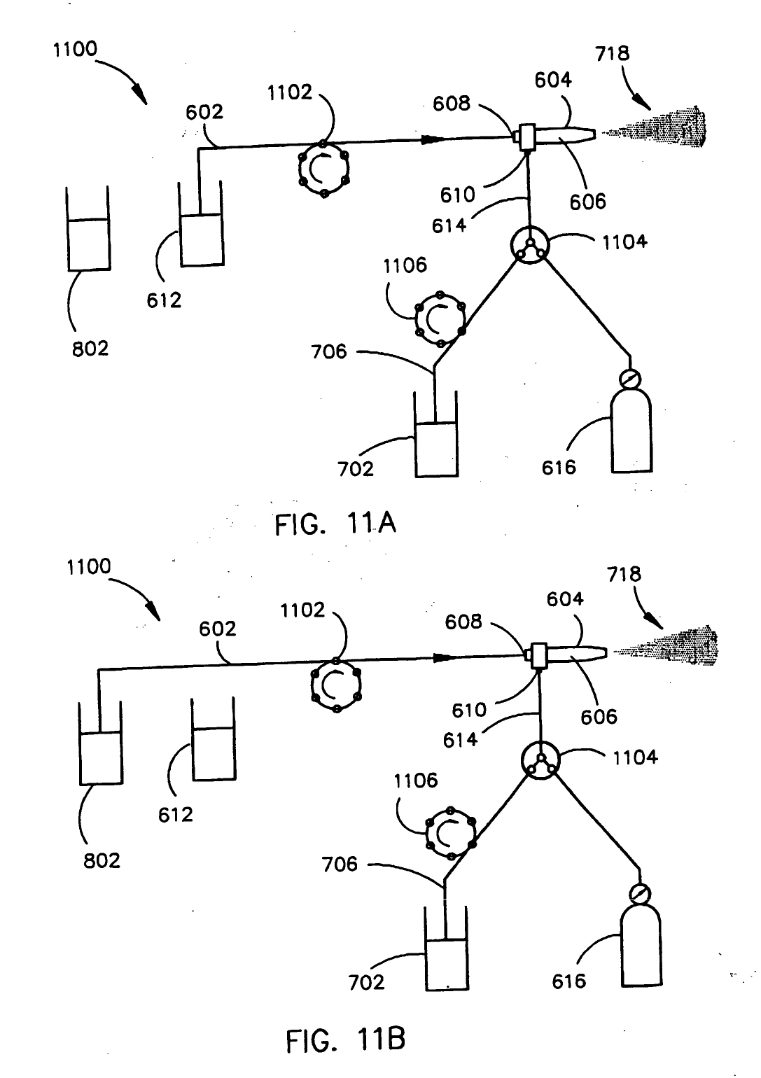

Referring to FIGS. 7A and 7B, detailed schematic illustrations of a first embodiment of a system 700 for development of a nebulized sample are shown. Specifically, FIG. 7A is a detailed schematic illustration of a first embodiment of a system 700 for development of a nebulized sample in analysis mode according to an exemplary embodiment of the invention, and FIG. 7B is a detailed schematic illustration of a first embodiment of a system 700 for development of a nebulized sample in rinse mode according to an exemplary embodiment of the invention. System 700 may comprise a liquid sample introduction line 602, and a nebulizer 604. The nebulizer 604 may further include an interior nebulizer portion 606 and a plurality of nebulizer ports 608, 610. At least one of the nebulizer ports 608, 610 may be a liquid sample receiving port 608, and at least one of the nebulizer ports may be a gas receiving port 610. System 700 may also comprise a sample reservoir 612, a gas transport line 614 and a gas source 616. The liquid sample introduction line 602 may transport a sample from a sample reservoir 612 to the nebulizer 604 via the liquid sample receiving port 608 and the gas transport line 614 may transfer a gas from a gas source 616 to the nebulizer 604 via the gas receiving port 610. Liquid sample receiving port 608 may direct a sample into the interior nebulizer portion 606, and the gas receiving port 610 may direct a gas into the interior nebulizer portion 606. In operation, a sample to be analyzed may be pumped by a pump 1102 (shown in FIG. 11) from source 612 to nebulizer 604 and gas may be directed by a regulator from a gas source 616 so that the aerosolized sample 618 may be ejected from nebulizer 604 into a spray chamber (not shown) where the aerosol may pass through a chamber outlet or a sample exit port of the chamber (not shown).

System 700 may also comprise a rinsing liquid reservoir 702 containing a rinsing liquid, a rinsing liquid transport line 704, and a valve assembly 706 configured to receive a nebulizer gas from a gas source 616 and a rinsing liquid from the rinsing liquid reservoir 704. Rinsing liquid may be a saline solution, an acid solution, or any solution suitable for rinsing the interior nebulizer portion 606. In the configuration described by FIGS. 7A and 7B, transport line 614 may be connected to the valve assembly 706 and to the gas receiving port 610. The gas transport line 614 is configured to provide transportation of a rinsing liquid through the gas transport line 614 to the gas receiving port 610 of the nebulizer 604 to rinse the interior nebulizer portion 606. The gas transport line 614 may alternately or simultaneously deliver gas from a gas source 616 and a rinsing liquid from a rinsing liquid reservoir 702 to the nebulizer 604. System 700 may further include an overflow transport line 710 and an overflow container 712 to collect any overflow rinsing liquid. Valve assembly 706 may further comprise at least one loop assembly 714 and a plurality of openable/closeable ports 708 configured to open and/or close to allow a gas, a rinsing liquid and/or a combination of a gas and a rinsing liquid to flow through the loop assembly 714 to the gas transport line or the overflow transport line 710 via port tubing connecting one or more ports together and/or to the loop assembly 714. Prior to introducing a subsequent sample into a spray chamber and/or a device for analysis, a solution 718 comprising the rinsing liquid and any residual amounts of the aerosolized sample which could contaminate the subsequent sample aerosol and provide erroneous analysis results, may be removed at least to a background level of the analysis.

As described above, valve assembly 706 may comprise a plurality of channel connected ports 708, and at least one loop assembly 714 configured to selectively receive at least one of a gas or a rinsing liquid. Valve assembly 706 may be moveable to a desired configuration. In one embodiment, valve assembly 706 is rotatable. Valve assembly 706 may also be a linear valve assembly, a three way valve assembly (as shown in FIG. 11), or any other mechanism for allowing a determined amount of at least one of a gas or liquid to pass through to a transport line such as the gas transport line 614 of FIGS. 6-8B and 11. For instance, loop assembly 714 may be configured in a first configuration allowing only a gas from a gas source 616 to be transported to the valve assembly 708. Valve assembly 708 may allow the gas to be transported from a port connected to the gas transport line 614 to the gas receiving port 610 of the nebulizer 604, as shown in FIG. 7A. Loop assembly 714 may be configured in further additional configurations allowing rinsing liquid to be transported through the loop assembly 714 to gas transport line 614, as shown in FIG. 7B. For instance, the valve assembly 706 may be configured in the second configuration and a rinsing liquid may be pumped from the rinsing liquid reservoir 702 by pump into the valve assembly 706 to fill the loop assembly 714. When loop assembly 714 is filled, valve assembly 706 may shift to a third configuration to allow the rinsing liquid to flow from the loop assembly 714 to a valve assembly port connected to the gas transport line 614. Loop assembly 714 may be further configured to allow a gas and a rinsing liquid to be transported through the loop assembly 714 to the gas transport line 614. Transport of gas, rinsing liquid or both through a loop assembly 714 may be accomplished without the development of an air bubble between individual substances or solutions as they are transported through the loop assembly 714. Transport of rinsing liquid through a loop assembly 714 may be accomplished by pushing gas from the gas source 616 behind an injection of rinsing liquid or pumping the rinsing liquid through the loop assembly 714 with a pump (as shown in FIG. 11).

When the valve is configured in analysis mode, as shown in FIG. 7A, the rinsing liquid from the rinsing liquid reservoir 712 may fill the loop assembly 714 and be directed to a valve assembly port connected to an overflow transport line 710 to transport the rinsing liquid to the overflow container 712. In an additional embodiment, the rinsing liquid may be transported through the loop assembly 714 and transported to a valve assembly opening connected to tubing configured to return the rinsing liquid to the rinsing liquid reservoir. If required, a valve assembly port may be positioned to allow gas under pressure from gas source 616 to force the rinsing liquid through the loop assembly 714 and to a valve assembly port connected to the gas transport line 614.

System 700 may further comprise a control assembly 716 for controlling the valve assembly 706. Control assembly 716 may provide periodic or intermittent introduction of the rinsing liquid into the interior portion of the nebulizer via the gas receiving port connected to the gas transport line. In one embodiment, the control assembly 716 is a general purpose computer system programmed to receive signal information from the detector and to control operation of the detector. In this embodiment, control assembly 716 has a conventional display, such as a cathode ray tube or a liquid crystal display monitor. The control assembly 716 also has user input mechanisms, such as a keyboard and mouse. In an embodiment, a touch screen user interface is used. In other embodiments, the valve assembly 706 may be manually operated/controlled.

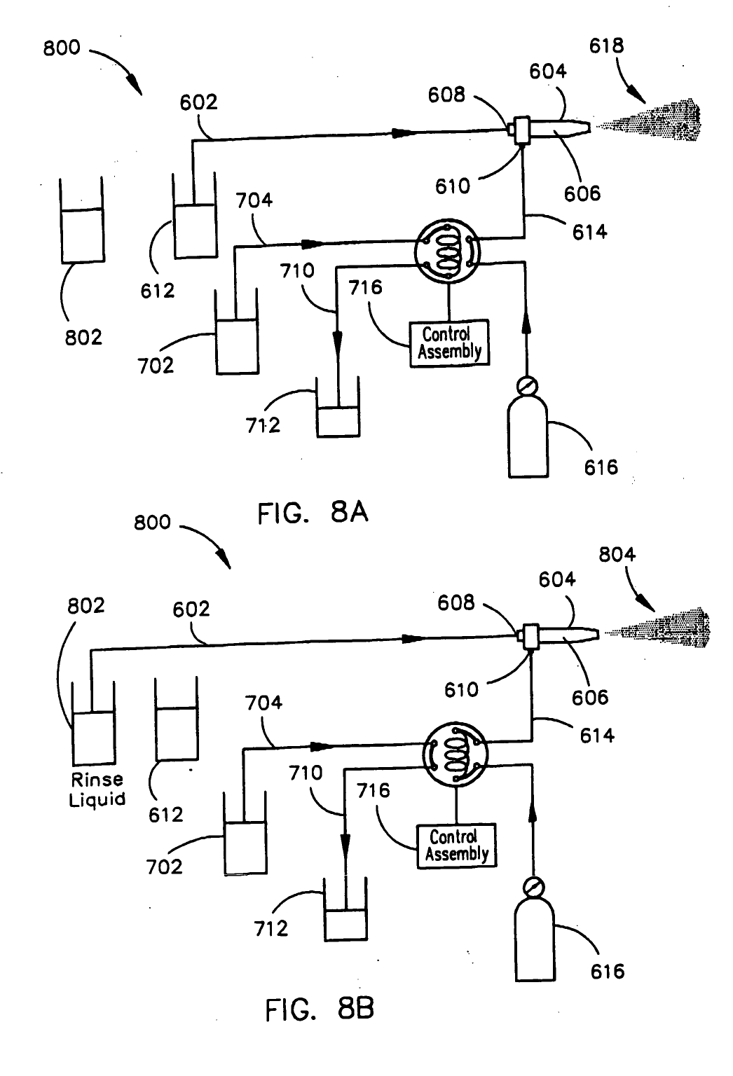

Referring to FIGS. 8A and 8B, detailed schematic illustrations of an additional system 800 for development of a nebulized sample are shown. Specifically, FIG. 8A is a detailed schematic illustration of a second embodiment of a system for development of a nebulized sample in analysis mode according to an exemplary embodiment of the invention, and FIG. 8B is a detailed schematic illustration of a second embodiment of a system for development of a nebulized sample. System 800 may comprise a sample introduction line 602, and a nebulizer 604 further comprising a sample receiving port 608 configured to receive a sample and a gas receiving port 610 configured to receive at least one of a nebulizing gas or a rinsing liquid, a valve assembly 706 configured to allow a portion of the gas and/or the rinsing liquid to flow therethrough, a control assembly 716 for controlling the valve assembly 706, a gas transport line 614 configured to transport one of the gas or the rinsing liquid to the gas receiving port and a second rinsing liquid reservoir 802 suitable for transporting a second rinsing liquid through the sample introduction line 602 into the nebulizer 604. The sample is nebulized within the nebulizer by applying a nebulizer gas to the sample within the nebulizer, the nebulizer gas being directed into the nebulizer through the gas receiving port from a nebulizer gas source 614 directed through a valve assembly 706, the valve assembly 706 configured to allow a portion of the nebulizer gas from the nebulizer gas source to flow therethrough, and the nebulizer is rinsed by directing a first rinsing liquid through valve assembly 706 to the gas transport line 614 and a second rinsing liquid through the sample introduction line to the sample receiving port. First and second rinsing liquids may be the composed of the same rinsing solution or may be composed of different solutions as required/desired by a system and/or an operator. First and second rinsing liquids may be acids, bases or any combination of liquids. System 800 may be configured in a manner similar to system 700, with the addition of the second rinsing liquid reservoir 802 and pump 1106 (shown in FIG. 11) configured to pump a second rinsing liquid through the sample introduction line 602. Prior to introducing a subsequent sample into a spray chamber and/or a device for analysis, a solution 804 that is a combination of the first and second rinsing liquids, along residual amounts of the aerosolized sample which could contaminate the subsequent sample aerosol and provide erroneous analysis results, may be removed at least to a background level of the analysis.

Referring to FIGS. 11A and 11B, a system 1100 for rinsing a nebulizer is shown. FIG. 11A is a detailed schematic illustration of a third embodiment of a system for development of a nebulized sample in analysis mode according to an exemplary embodiment of the invention. FIG. 11B is a detailed schematic illustration of a third embodiment of a system for development of a nebulized sample in rinse mode according to an exemplary embodiment of the invention. System 1100 may include a sample transport line 602 coupled to a sample reservoir 612 and at least one pump 1102 operable to pump a first rinsing liquid from a first rinsing liquid reservoir 802 (shown in FIG. 11B) through the sample transport line 602, a nebulizer 604 further including an interior portion 606, a sample receiving port 608, a gas receiving port 610, a gas transport line 614 coupled to a three-way valve assembly 1104. Three way valve assembly 1104 may comprise inputs for receiving a gas transport line 614 and a rinsing liquid transport line 706 coupled with a second pump 1106 operable to pump a rinsing liquid to from a rinsing liquid source 702 to the nebulizer 604 (i.e., into interior portion of the nebulizer 606). In operation, a sample to be analyzed may be pumped by pump 1104 from source 612 to nebulizer 604 and gas is passed by a regulator from a gas source 616 so that the combination of the first rinsing liquid and the second rinsing liquid 718 may be ejected from nebulizer 604 into a spray chamber (not shown) where the aerosol may pass through a chamber outlet or a sample exit port of the chamber.

In one embodiment, the nebulizer 604 is a pneumatic nebulizer constructed from PFA Teflon™, such as the nebulizers available from Elemental Scientific, Inc. of Omaha, Nebr. In one embodiment, the sample introduction line 602, the gas transport line 614, and the rinsing liquid transport line 704 are constructed from a hydrophobic material suitable for preventing droplet breaking, such as PFA Teflon material. The liquid sample introduction line 602, the gas transport line 614, and the rinsing liquid transport line 704 may be any diameter or length suitable for delivery of a sample, gas or rinsing liquid as necessary. In alternative embodiments, the liquid sample introduction line 602, the gas transport line 614, and the rinsing liquid transport line 704 may include an anti-static exterior sheath, such as a carbon filled polymer sheath. It is understood that other anti-static mechanisms can be employed to dissipate static electrical charges in the vie departing from the teachings of the present invention, such as anti-static air shower systems. At least a portion of the nebulizer may also be hydrophilic, and/or formed from glass or any other material suitable for constructing a nebulizer.

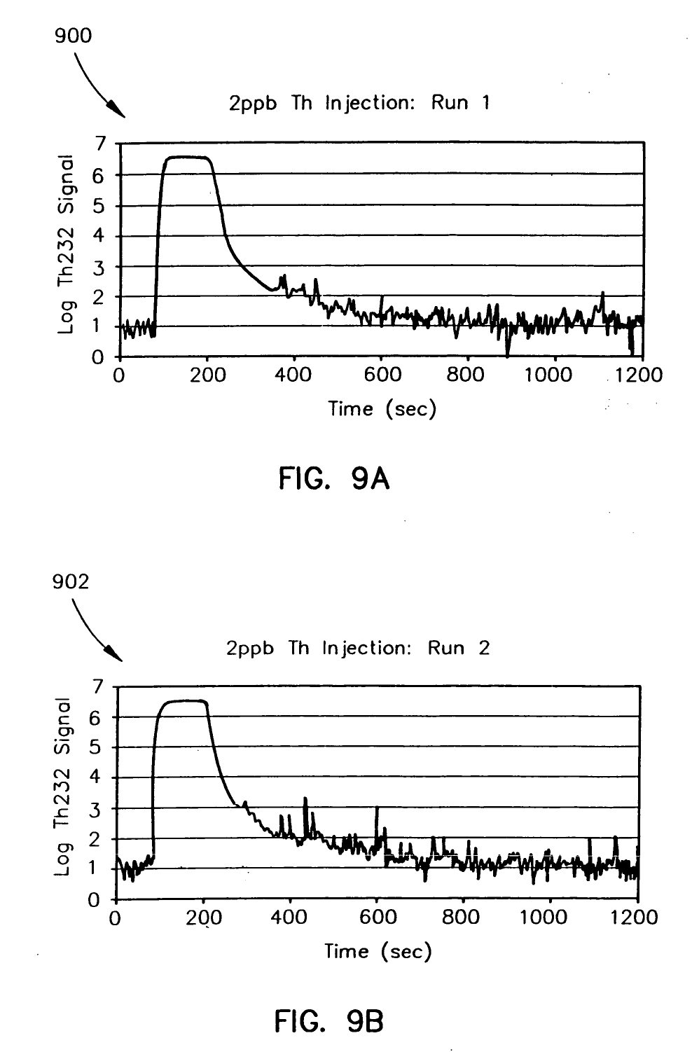

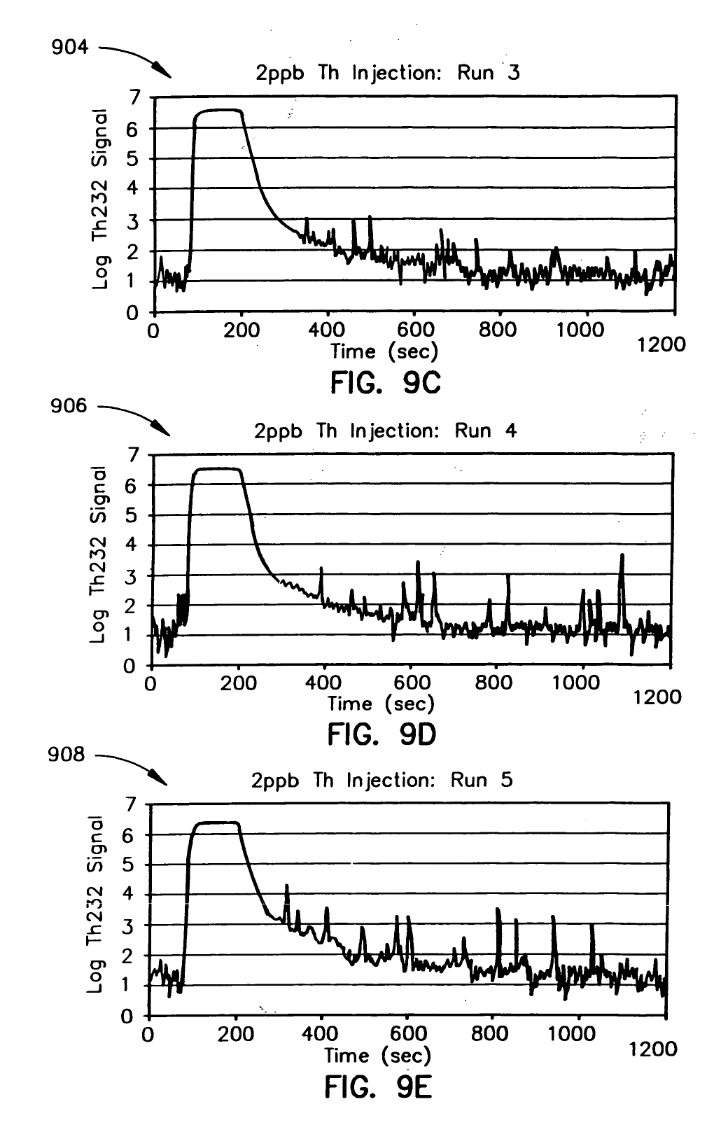

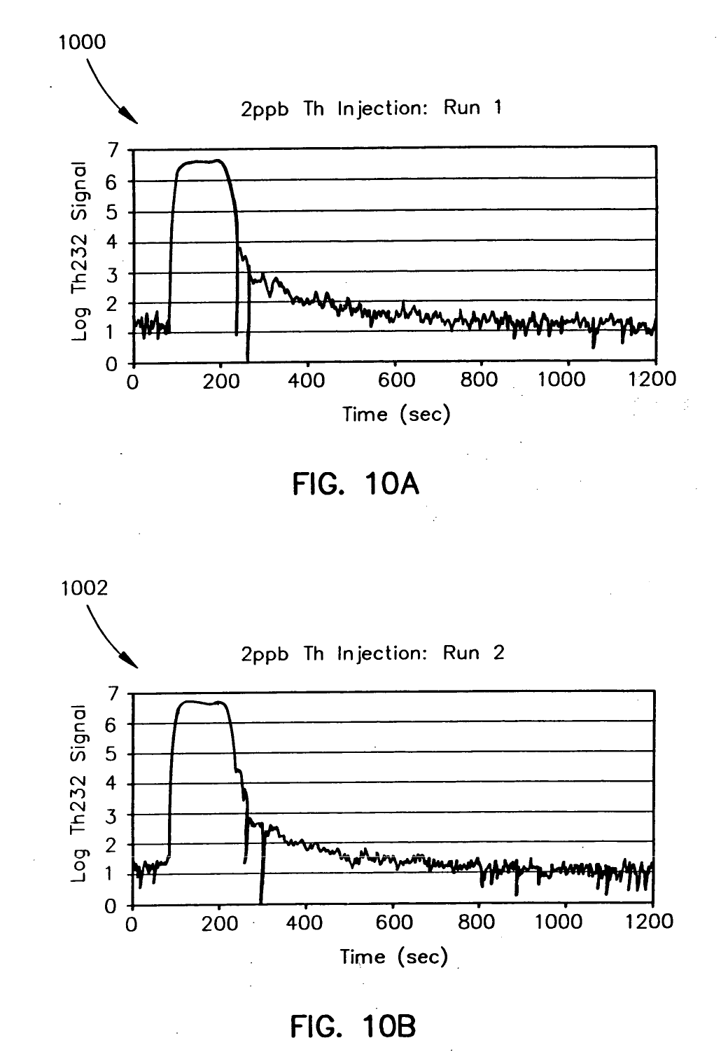

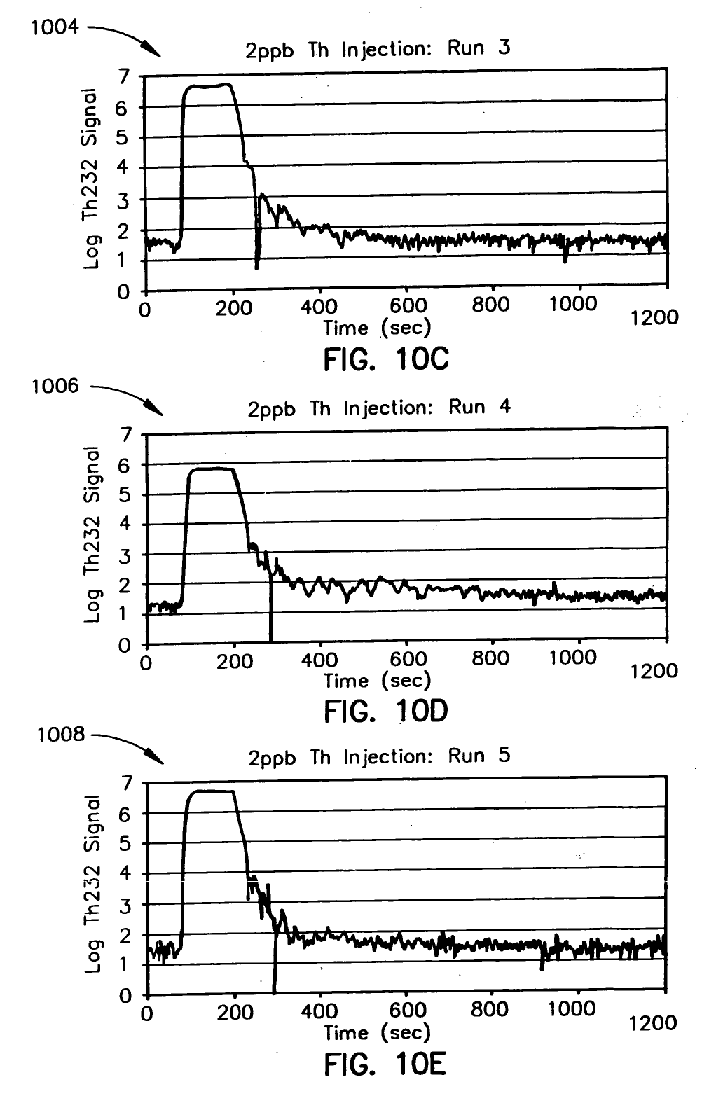

FIGS. 9A-9E are graphical illustrations of subsequent samples run through a conventional system plotted as the on-line intensity for Thorium on a logarithmic scale. After 5 injection runs, large increases in signal spikes due to the reaspirated sample are seen when utilizing a conventional rinse method. FIGS. 10A-10E are graphical illustrations of subsequent samples run through a nebulizer having system 700 according to exemplary embodiments of the invention plotted as the on-line intensity for Thorium on a logarithmic scale. The signal levels averaged zero during every run, with no build up of reaspirated sample causing undesireable spiking.

It is believed that the present invention and many of its attendant advantages will be understood by the foregoing description. It is also believed that it will be apparent that various changes may be made in size, materials, shape, form, function, manner of operation, assembly and use of the components thereof without departing from the scope and spirit of the invention or without sacrificing all of its material advantages. The form herein before described being merely an explanatory embodiment thereof. Further, it is contemplated that the specific order or hierarchy of steps in the method can be rearranged while remaining within the scope and spirit of the present invention. It is the intention of the following claims to encompass and include such changes.

What is claimed:

1. A method for providing rinsing of a nebulizer comprising:
directing a first rinsing liquid through a sample transport line to a sample receiving port of a nebulizer;
directing a second rinsing liquid followed by a nebulizing gas to a gas receiving port of the nebulizer through a valve assembly, the valve assembly being connected to a gas transport line configured to transport at least one of the nebulizing gas and the second rinsing liquid to the gas receiving port;
rinsing the sample transport line and an interior portion of the nebulizer with the first rinsing liquid; and
rinsing an interior portion of the nebulizer with the second rinsing liquid transported through the gas transport line into the interior portion of the nebulizer via the gas receiving port.

2. The method of claim 1, wherein the directing a first rinsing liquid through a sample transport line to a sample receiving port of a nebulizer comprises:
directing a first rinsing liquid through a sample transport line to a sample receiving port of a nebulizer formed from a hydrophobic material suitable for preventing droplet breaking.

3. The method of claim 1, wherein the directing a first rinsing liquid through a sample transport line to a sample receiving port of a nebulizer comprises:
directing a first rinsing liquid through a sample transport line to a sample receiving port of a nebulizer formed from a hydrophilic material.

4. The method of claim 1, wherein the directing a first rinsing liquid through a sample transport line to a sample receiving port of a nebulizer comprises:
directing an acid or a base rinsing liquid into an interior portion of the nebulizer through the sample receiving port.

5. The method of claim 1, wherein the directing a second rinsing liquid followed by a nebulizing gas to a gas receiving port of the nebulizer through a valve assembly, the valve assembly being connected to a gas transport line configured to transport at least one of the nebulizing gas and the second rinsing liquid to the gas receiving port comprises:
electronically controlling the valve assembly to introduce the rinsing liquid through the gas port.

6. The method of claim 1, wherein the directing a second rinsing liquid followed by a nebulizing gas to a gas receiving port of the nebulizer through a valve assembly, the valve assembly being connected to a gas transport line configured to transport at least one of the nebulizing gas and the second rinsing liquid to the gas receiving port comprises:
manually controlling the valve assembly to introduce the rinsing liquid through the gas port.

7. The method of claim 1, wherein the directing a second rinsing liquid followed by a nebulizing gas to a gas receiving port of the nebulizer through a valve assembly, the valve assembly being connected to a gas transport line configured to transport at least one of the nebulizing gas and the second rinsing liquid to the gas receiving port comprises:
utilizing the nebulizing gas to push the second rinsing liquid through a loop assembly disposed within the valve assembly and through the gas transport line.

8. The method of claim 1, wherein the directing a second rinsing liquid followed by a nebulizing gas to a gas receiving port of the nebulizer through a valve assembly, the valve assembly being connected to a gas transport line configured to transport at least one of the nebulizing gas and the second rinsing liquid to the gas receiving port comprises:
utilizing a pump to pump the second rinsing liquid through a loop assembly

8. The method of claim 1, wherein the directing a second rinsing liquid followed by a nebulizing gas to a gas receiving port of the nebulizer through a valve assembly, the valve assembly being connected to a gas transport line configured to transport at least one of the nebulizing gas and the second rinsing liquid to the gas receiving port comprises:
utilizing a pump to pump the second rinsing liquid through a loop assembly disposed within the valve assembly and through the gas transport line.

9. The method of claim 1, wherein the directing a second rinsing liquid followed by a nebulizing gas to a gas receiving port of the nebulizer through a valve assembly, the valve assembly being connected to a gas transport line configured to transport at least one of the nebulizing gas and the second rinsing liquid to the gas receiving port comprises:
directing an acid or a base rinsing liquid into an interior portion of the nebulizer through the gas receiving port.

10. The method of claim 1, wherein the directing a second rinsing liquid followed by a nebulizing gas to a gas receiving port of the nebulizer through a valve assembly, the valve assembly being connected to a gas transport line configured to transport at least one of the nebulizing gas and the second rinsing liquid to the gas receiving port comprises:
directing a second rinsing liquid followed by a nebulizing gas to a gas receiving port of the nebulizer through a valve assembly that is at least one of a three-way valve assembly, a linear valve assembly, or a rotatable valve assembly.

11. A nebulizer rinsing system comprising:
a liquid sample introduction line;
a nebulizer including a plurality of nebulizer ports, at least one of the nebulizer ports being a liquid sample introduction line receiving port and at least one of the nebulizer ports being a gas receiving port;
a valve assembly configured to receive a nebulizer gas and a rinsing liquid; and
a transport line including a first end connected to the valve assembly and a second end connected to the gas receiving port,
wherein the transport line is configured to provide transportation of a rinsing liquid through the transport line to the gas receiving port of the nebulizer to rinse an interior portion of the nebulizer.

12. The nebulizer rinsing system of claim 11, wherein the nebulizer is formed from a hydrophobic material suitable for preventing droplet breaking.

13. The nebulizer rinsing system of claim 12, wherein the hydrophobic material is Teflon.

14. The nebulizer rinsing system of claim 11, further comprising a loop assembly disposed within the valve assembly.

15. The nebulizer rinsing system of claim 14, wherein the gas pushes the rinsing liquid through the loop assembly to the gas transport line.

16. The nebulizer rinsing system of claim 14, wherein a pump pumps the rinsing liquid through the loop assembly to the gas transport line.

17. The nebulizer rinsing system of claim 11, further comprising a control assembly configured to electronically control the valve assembly to introduce the rinsing liquid through the gas port.

18. The nebulizer rinsing system of claim 11, wherein the valve assembly is manually controlled.

19. The nebulizer rinsing system of claim 11, wherein the valve assembly is at least one of a three-way valve, a linear valve, or a rotatable valve.

20. The nebulizer rinsing system of claim 11, wherein the rinsing liquid is an acid or a base rinsing liquid.

21. A nebulizer rinsing system comprising:
a sample introduction line;
a nebulizer further comprising a sample receiving port configured to receive a sample and a gas receiving port configured to receive at least one of a nebulizing gas from a gas source or a first rinsing liquid from a first rinsing liquid reservoir;
a valve assembly configured to allow a portion of the gas or the rinsing liquid to flow therethrough;
a gas transport line configured to transport at least one of the gas or the first rinsing liquid into an interior portion of the nebulizer through the gas receiving port; and
a second rinsing liquid reservoir suitable for providing a second rinsing liquid transportable through the sample introduction line into an interior portion of the nebulizer through the sample receiving port.
